(19) United States
(12) Patent Application Publication
(10) Pub. No.: US 2016/0110505 A1
(43) Pub. Date: Apr. 21, 2016

(54) Platform for the Storage, Management and Analysis of Consolidated Electronic Health Records

(71) Applicant: PERVASIVE HEALTH, INC., Chicago, IL (US)

(72) Inventors: Aaron Symanski, Chicago, IL (US); Michael Oltman, Oak Park, IL (US)

(21) Appl. No.: 14/894,301

(22) PCT Filed: May 28, 2014
(86) PCT No.: PCT/US14/39787

§ 371 Date: Nov. 25, 2015

Related U.S. Application Data
(60) Provisional application No. 61/828,075, filed on May 28, 2013.

(51) Int. Cl. G06F 19/00; H04L 29/08

(52) U.S. Cl. CPC G06F 19/322; H04L 67/32

(57) ABSTRACT

A system for the storage, management and analysis of electronic health records (“EHRs”) is provided. The system comprises an EHR analysis system in communication with one the EHR systems of one or more healthcare provider enterprises via a network, such as the internet. The EHR analysis system receives and stores in a database EHR data and information identifying the format the data is stored in, and is capable of transmitting the data in the same or different format. The system also includes an authoring platform for building and publicizing applications to analyze stored EHR data, allow end users to run the applications on the stored data and present the results of the applications to the end users.

### CROSS-REFERENCE TO RELATED APPLICATION

The application claims the benefit of U.S. provisional application No. 61/828,075, filed May 28, 2013, now pending.

### BACKGROUND OF THE INVENTION

a. Field of the Invention

The instant invention relates to the management, collaboration and use of electronic health records (EHRs). In particular, the instant invention relates to systems and methods for managing, analyzing and sharing of EHR data and for providing an authoring platform for the creation of analysis tools for EHR data.

b. Background Art

Within the last four years in the United States, the adoption and use of electronic health records has dramatically increased. In 2009, only 12% of non-federal acute hospitals had adopted a basic electronic health record (EHR) system and less than 3% had adopted a comprehensive EHR system. By 2012, the percentage of non-federal hospitals using a basic EHR system was up to 44%. During this same time period, adoption of EHR systems by office-based physicians increased from 22% in 2009 to over 40% in 2012. Other countries have also experienced growth in the adoption of EHR systems over the last several years. Policy initiatives and recent laws undertaken by countries around the world, including the Patient Protection and Affordable Care Act in the United States, have included provisions to encourage, support and mandate an even greater adoption of EHR systems by providers in almost all care delivery settings.

One of the stated policy goals of wide-spread adoption of EHR systems is the creation of a comprehensive patient centered, information rich health care system where a person's health information can follow them wherever they access health care services. To achieve this goal, data exchange and collaboration between EHR systems of various diverse providers is necessary. However, the development of EHR systems is fragmented with multiple software consultants and vendors. Many of the installed EHR systems are thus proprietary to a vendor or are developed for a specific provider and cannot be readily adapted for others. Some providers may even have different systems within their same enterprise, such as where systems have been developed at different times or acquired through mergers. The many different types of EHR systems installed thus make it difficult to easily exchange information between them.

The problems addressed above could be solved with a uniform standard for EHR systems, making the exchange of information between EHR systems much simpler. However, many providers have already invested significantly in their currently installed systems, in both time and money. The additional sums that would be necessary to adopt a new system or even to modify an existing installation would be prohibitive for many providers. Furthermore, any new system or modification would most likely require additional time and resources for training of the individual physicians, nurses, technicians and other individual providers.

Where an exchange of information is required between multiple EHR systems, a custom solution is often required, which can also be costly and time consuming.

Another impediment to ease of sharing information between diverse EHR systems involves the medical vocabularies used to describe the health information stored in the EHR system. There are several different medical vocabularies available, with many providers using one of the vocabularies developed by various standards bodies, such as, for example, the Systematized Nomenclature of Human and Veterinary Medicine (SNOMED), International Classification of Diseases (ICD) and Logical Observation Identifier Names and Codes (LOINC), etc.). Each of these standard vocabularies are intended to be used for almost all health care delivered in any environment (e.g., physician's offices, acute care facilities, long term care, laboratories, etc.). Other providers have developed and utilize their own internal vocabularies. Just as there can be different EHR systems in use within the same provider's enterprise, there may also be instances where the same provider has more than one standard vocabulary system in use. The absence of a uniform vocabulary for the health care information related to a single person stored in the EHR systems of all the different health care providers visited by that person is another impediment to reaching the goal of a comprehensive health care system.

Thus, even when the technical difficulties of exchanging information between EHR systems can be overcome, there is still the significant problem of making the information in the diverse EHR system compatible with each other. While some efforts have been made to set a common method for the exchange of information (such as CONNECT developed by the National Health Information Network), there are no generally adopted standards for sharing information between EHR systems.

A comprehensive EHR system can allow an individual provider to obtain information about its patient population that that will allow it to make better diagnostic decisions about individual patients and to review and improve its own policies and procedures. For example, analysis of the health data across all of a hospital's patients, for example, can be used to help predict an individual patient's risk of disease or the potential outcomes for different treatment options.

The prevention of MERSA infections is currently a high priority for hospitals and other providers. Data on the infection rates may only be available on a facility-wide or unit-wide basis, with possibly some patient demographic data factored into it as well. Access to a comprehensive EHR system, however, having complete health records for patients, would allow a hospital to identify and assess all of the risk factors for infection. The hospital can then take targeted steps that focus on the specific risks rather than implement facility-wide procedures that may not be applicable or effective throughout the facility.

While being able to analysis the comprehensive data contained in an EHR system would have tremendous benefits to providers, it can be costly to develop and implement such analysis tools. Additionally, research in the medical arts is constantly developing new methods to analyze health data as well as new models for predictive diagnosis based on that analysis. While some providers may have the resources to employ teams of software developers to develop specific analysis tools for its data, most do not and would have to rely on vendors and outside developers to do so. Given the variety of the EHR systems currently deployed, the lack of standardization and the various medical vocabularies used, most analytical tools need to be customized for each particular installation.

Furthermore, individual vendors may be able to develop special expertise in analyzing health data for particular types of diseases or diagnoses. For example, researchers specializing in diabetes may develop a new model for predicting certain complications or outcomes when specific indicators are present in a patient's health record. The model can be built into an analytical tool that a provider can use to assess and diagnose it individual patients. However, the fact that the tool will need to be adapted for each type of EHR system installed and for each medical vocabulary used may inhibit the tool from being widely available, thus limiting its usefulness across the greater population.

Lastly, with the vast amount of patient information collected by providers, there is a desire for such data to be made available, without patient identifiable information, to researchers in a variety of medical fields. However, for researchers to obtain data from a sufficient number of patients meaningful and significantly significant, they must contact and obtain EHR data from many different providers. Thus, the researchers may have to interact with a number of different EHR systems using several different medical vocabularies, for which the resources may not be available. It may further be desirable for researchers to analyze patient information on a real-time basis which would require an even more sophisticated data exchange solution than would be required for a one-time exchange of historic data. Furthermore, providers may desire to make their data available to a wide variety of researchers studying different topics, but might not have the internal resources that would be necessary to manage the technical and privacy aspects of sharing patient health information.

There is a need therefore for systems and methods to allow for collaboration and sharing of patient health information across diverse EHR systems that are agnostic to the medical vocabularies used to catalog and characterize that data. There is further a need for a platform in which tools for analyzing patient health information for various purposes can be developed and easily deployed across a variety of EHR systems and for a variety of medical vocabularies. There is still further a need in which medical researchers and other interested stakeholders can access anonymous patient health data in the EHR systems of multiple providers while allowing the providers to control the parameters of such access.

### BRIEF SUMMARY OF THE INVENTION

It is desirable to be able to provide computer based systems and methods that can provide access to patient health information data and allow for the development of analytical tools that can be easily adopted for and used on any EHR system regardless of the technology and of the medical vocabulary or coding scheme used to catalog and describe the data. The present invention provides such comprehensive systems and methods.

In one aspect of an embodiment of the present invention, a computer-based system is provided for creating a shared record database in which individual patent data from multiple EHR systems, either from within a single provider or from multiple providers, can be created and made accessible to all providers of health care services to that individual patent. The import of data into the system is without regard to the type of EHR system or medical vocabulary used to originally store the data. The system can also provide access to the data in the requesting provider's desired format and vocabulary. A provider is therefore not required to adopt a new EHR system, or even modify its existing system, in order to achieve the objectives of full patient health record collaboration.

In another aspect of an embodiment of the present invention, a shared record database is created from multiple EHR systems. The collected data is stored along with the medical vocabulary, or ontology, that was used to originally store it, then organized and enhanced using a standard ontology to provide native clinical significance to the data.

In still another aspect of an embodiment of the invention, a platform for the analysis and evaluation of patient health data collected from one or more EHR systems is provided. Analytical algorithms can be provided and made available to a provider on the platform so that the provider can run evaluate their own comprehensive patient data. Such analysis can be performed on an individual patient level, where predictive models can be used to make diagnostic decisions related to the specific health care to be provided to patients. Analysis can further be performed on a facility or enterprise basis, in which case evaluation of all or a subset of all patients of a provider can be evaluated to determine effectiveness of the provider's procedures, for example. Lastly, providers may be able to analyze and evaluate larger data sets from multiple other providers, anonymous across all patients, in order to analyze and determine best practices for care of specific conditions.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a representation of a system according to one aspect of an embodiment for the management and analysis of health information contained in the EHR systems of one or more healthcare enterprises.

FIG. 2 illustrates the basic architecture for one aspect of an embodiment of a website which facilities the implementation of the system of FIG. 1.

FIG. 3 illustrates the architecture for a sub site of the web site of FIG. 2 relating to end users of healthcare provider enterprises.

FIG. 4 illustrates the architecture for a subsite of the website of FIG. 2 relating to a platform for authoring health analysis tools.

FIG. 5 illustrates the architecture for a sub site of the web site of FIG. 2 relating to application developers.

FIG. 6 illustrates the architecture for a subsite of the website of FIG. 2 relating to healthcare provider enterprise administrators.

FIG. 7 illustrates the architecture for a sub site of the web site of FIG. 2 relating to healthcare researchers.

FIG. 8 illustrates the architecture for a sub site of the web site of FIG. 2 relating to the administration of the website of FIG. 2.

### DETAILED DESCRIPTION OF THE INVENTION

A system is described herein that helps solve some of the deficiencies of the prior art methods of consolidated electronic health records across disparate systems and making the data useful for a clinical setting. The system achieves these results by providing the ability to store EHR data in a consolidated fashion, irrespective of the medical vocabulary, ontology or coding format used to initially create and ultimately store the data. Furthermore, the system is then able to coherently report that data back to the healthcare provider using any medical vocabulary, ontology or coding format desired.

The system further provides for the ability of third party application developers to author insight tools that can analyze the consolidated EHR data and provide relevant clinical action plans to the healthcare provider. The ability of the system to report consolidated EHR data across any known medical vocabulary, ontology and coding format allows the application developer to create an insight tool that can be used by multiple healthcare providers, regardless of the format their EHR data is maintained in. In this way, the described system provides a platform for application developers to offer their insight tools to a number of healthcare providers without the need to customize the application to accommodate the format of the provider's EHR data.

The system also provides a mechanism for healthcare providers, as the owner of the consolidated EHR data residing on the system, to allow access to the data for research and other appropriate purposes. Likewise, the system creates the ability for researchers to obtain access to large amounts of patient health data in an easily accessible manner, without having to deal with large amounts of EHR data in multiple different formats. Further, the system allows researchers and healthcare providers to work directly with each other, in aggregation, without third party intervention. The enormous benefit that researchers can obtain by having access to the consolidated EHR data creates an opportunity for healthcare providers to seek and obtain financial compensation for providing access to the data. The system further may provide mechanisms to facilitate financial transactions between researchers and the owners of the consolidated EHR data.

The System

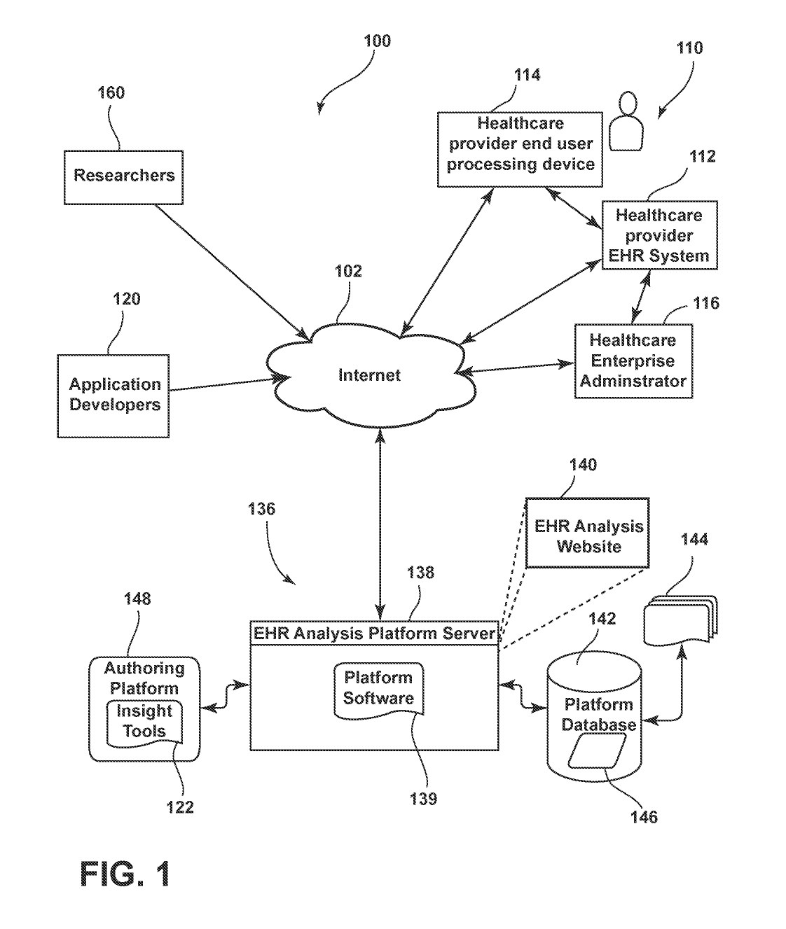

Illustrated in FIG. 1 is a system 100 that provides for the management and analysis of health information contained in the EHR systems 112 of one or more healthcare enterprises 110. In an embodiment, a healthcare enterprise may be any type of entity providing healthcare, including acute care hospitals, long term care facilities, rehabilitation facilities, physician's offices, dentist's offices, immediate care clinics, pharmacies and independent laboratories, such as biological testing facilities and imaging facilities.

System 100 provides for a browser based architecture in an EHR analysis platform 136 connected to the internet 102, the platform 136 comprising an EHR analysis platform server 138, an EHR analysis website 140 and an EHR analysis platform database 142.

In the system 100, patient information located on one or more EHR systems 112 of a healthcare enterprise 110 is transferred to and consolidated in the platform database 142. The consolidated EHR data 146, consisting of all patient facts, events, and observations contained in the one or more EHR systems 112, is defined within the platform database 142 using concepts from an integrated clinical knowledge base 144. Infusing the consolidated EHR data 146 with clinical meaning from the clinical knowledge base 144 provides a single, simple representation for patient health data that was previously disparate and disorganized and allows access and reporting without knowledge of the original data source or structure.

The system 100, through the EHR analysis website 140, provides for the ability of one or more healthcare provider end users 114 from a healthcare enterprise 110 to access the healthcare enterprise 110's consolidated EHR data 146 in multiple formats and for multiple purposes, as further described below. In an embodiment, a healthcare provider end user may include physicians, physician assistants, nurses, etc. Access to this comprehensive and diverse patient information contained in the consolidated EHR data 146 means that any healthcare professional dealing with a patient episode can quickly uncover important patient insights, and better understand the end-to-end patient experience. While a healthcare provider end user has been described as having a direct healthcare providing role, it should be understood that an end user 114 is not limited to such roles. For example, administration staff of a healthcare enterprise may have an interest in information derived from the consolidated EHR data 146 that will assist in the administration of the healthcare enterprise, such as statistics on patient population data, length of hospital stay, patient infection rates, effectiveness of implemented policies and procedures, etc.

In an embodiment, the system 100 provides for the ability of healthcare enterprise administrators 116 to define and control the access rights to the consolidated data 146 of the healthcare enterprise 110. As described further herein, user access rights can based on multiple factors related to the organization, the user, the patient or the specific type of data as well known in various database environments. For example, a physician end-user 114 may have access to all information about her patients but may only have non-identifying health-related information about other patients of the healthcare enterprise 110.

In an embodiment, the EHR analysis platform 136 of system 100 further provides an authoring platform 148 that provides a system and methods for application developers 120 to design, create and commercialize applications and tools to analyze the consolidated EHR data 146 and provide insights into patient health. An example of such an application or tool is an application for the prediction of diabetes based on certain health indicators. Further examples are described below. The applications and tools, referred to as insight tools 122, can be offered by application developers 120 to healthcare enterprises 110 through the EHR analysis platform 136, on commercial terms agreed to between the application developers 120 and the healthcare enterprises 110. Access to the acquired insight tools 122 can then be provided to one or more end users 114 of the healthcare enterprise 110 through the EHR analysis website 140. Execution of an insight tool 122 on the consolidated EHR data for an individual patient can provide point-of-care recommendations to a physician or other healthcare provider end-user 114.

In an embodiment, the system 100 further provides for the ability of a healthcare enterprise 110 to provide access to its consolidated EHR data 146 to thirty-party researchers 160, such as governmental centers and agencies, universities, research foundations and private medical research facilities. The system 100 can accommodate and implement the necessary patient privacy and access restrictions required for sharing such data under applicable laws and regulations. The system 100 may allow researchers 160 to access the consolidated EHR data 146 from multiple healthcare enterprises 110, thus giving them access to vast amounts of clinically meaningful data across wide patient populations. In one embodiment, researchers 160 may have access to the authoring platform 148, allowing them to develop insight tools 122 for their own analysis of the multiple consolidated EHR data 146. In another embodiment, researchers 160 could obtain use of insight tools 122 from application developers 120 in the same manner that healthcare enterprises 110 obtain use of the insight tools 122.

The system 100 can further include the ability for the healthcare enterprise 110 to set the terms and conditions for granting access to the consolidated EHR data 146. For example, in one embodiment, the system 100 is configured to allow the healthcare enterprise 110 to offer access to some or all of its consolidated EHR data 146 to a researcher 160 for a limited amount of time, for use with only certain insight tools 122, for exclusive access to the results or on specific financial terms. This aspect of the system 100 can allow a healthcare enterprise 110 to recoup some of the significant technology investment required to implement, maintain and improve EHR systems.

The functions, tools and other services offered and provided by the EHR analysis website 140, the platform database 142 and the authoring platform 148 are carried out by, in one embodiment, platform software 139 running on EHR analysis platform server 138, which comprises at least one processing device. In embodiments, EHR analysis platform server 138 may have far greater processing devices. In other embodiments, a processing device may represent multiple hardware components or a network of distributed processing devices or hardware components. Processing devices may be coupled to internet 102 by way of a wired or wireless connection, singly or in combination. In embodiments, a processing device may include a mainframe computer, server, desktop computer, laptop computer, or an equivalent. In an embodiment, a processing device includes at least one integrated circuit processor that executes machine readable instructions or software stored on a storage device.

In other embodiments, multiple different servers and/or processing devices can be used for the EHR analysis website 140, the platform database 142 and/or the authoring platform 148. Furthermore, while the various components of the EHR analysis platform 136 can be part of a physically connected unit as depicted in FIG. 1, one of ordinary skill in the art should understand that the components do not need to be physically connected to each other for the EHR analysis platform to function effectively. For example, the platform database 142 could be located in a cloud hosting environment and accessible to the other components in the EHR analysis platform 136 over the internet 102.

For convenience, information is described herein as being transferred to and from EHR analysis web site 140; however, one of ordinary skill in the art understands that information is actually transferred to and from EHR analysis platform server 138. Similarly for convenience, EHR analysis website 140 is described herein as processing information when in actuality EHR analysis platform server 138 and platform software 139 is actually performing the processing.

The platform database 142 of the EHR analysis platform 136 can be set up as a fully semantic database platform. The platform database 142 may be a system configured to receive data comprising one or more events from a healthcare enterprise EHR system 112 and store the one or more events, each event comprising one or more facts, each fact comprising a value and an indication of the vocabulary of which the value is a member. The data structure in the platform database 142 may allow the healthcare enterprise administrator 116 to define the types of information from the healthcare provider EHR system 112 that will be stored in the platform database 142 according to the healthcare enterprise 110's own semantic vocabulary or ontology. The interface to the platform database 142 may also be structured and presented to accept data according to the healthcare enterprise 110's own semantic vocabulary or ontology.

As previously noted, portions of the information contained in the healthcare enterprise EHR system 112 may be defined by the healthcare enterprise 110 using a particular medical vocabulary or ontology, such as ICD-9, for example. When the data is transmitted to the platform database 142 for storage, the code set used to define the data is stored along with it. The healthcare enterprise 110 may later retrieve the data from the platform database 142 in the original code set format without conversion by the platform database 142 or by the healthcare enterprise 110.

The EHR analysis platform server 138 and the platform database 142 may also be configured, in some embodiments, to be able to convert the data stored in the platform database 142 into a different vocabulary or ontology from which it was originally stored. Such function is particularly beneficial in situations where a healthcare enterprise 110 may have more than one EHR system 112, each using different medical ontologies, such as ICD-9 and ICD-10, for example. Data relating to a specific patient may reside in more than one EHR system 112, and thus may be defined and stored using different medical ontologies. The patient data is still stored in the platform database 142 in its original coding format. The EHR analysis platform 136 can be configured to allow a healthcare end-user 114 to retrieve all data for the specific patient in a uniform coding format, including one of the original coding formats or a completely different coding format.

The Website

EHR analysis website 140, in an embodiment, is a collection of related web pages, web apps, images, videos and other digital services that is hosted on one or more processing devices which are part of the EHR analysis platform server 138 and is accessible via the Internet 102 by client processing devices. In an embodiment, a web page is a digital document that may be written in HTML (Hypertext Markup Language) or an equivalent. The HTML document may be accessible via HTTP (Hypertext Transfer Protocol), a protocol that transfers information from a processing device to another processing device in response to a request. In an embodiment, one or more client processing devices in system 100 include a HTML-compatible browser to view HTML web pages. In an embodiment, a client processing device may include a mainframe computer, server, desktop computer, web terminal, laptop computer, netbook computer, hand-held computer, tablet, smartphone, or an equivalent.

In an embodiment, HTML documents are provided from at least one processing device in EHR analysis platform sever 138 to client processing devices at healthcare provider end users 114, healthcare enterprise administrator 116, application developers 120, and researchers 160 in response to a request. HTML provides basic document formatting and allows “links” or “hyperlinks” to other processing devices (or servers) and files. A link such as a Uniform Resource Locator (“URL”) has a specific syntax that identifies a network path to a server for defining a network connection. Embedded hyperlinks on a given web page can be used to find information related to the given web page. By clicking on a hyperlink in one web page, the user can display another related web page or even invoke a related software program.

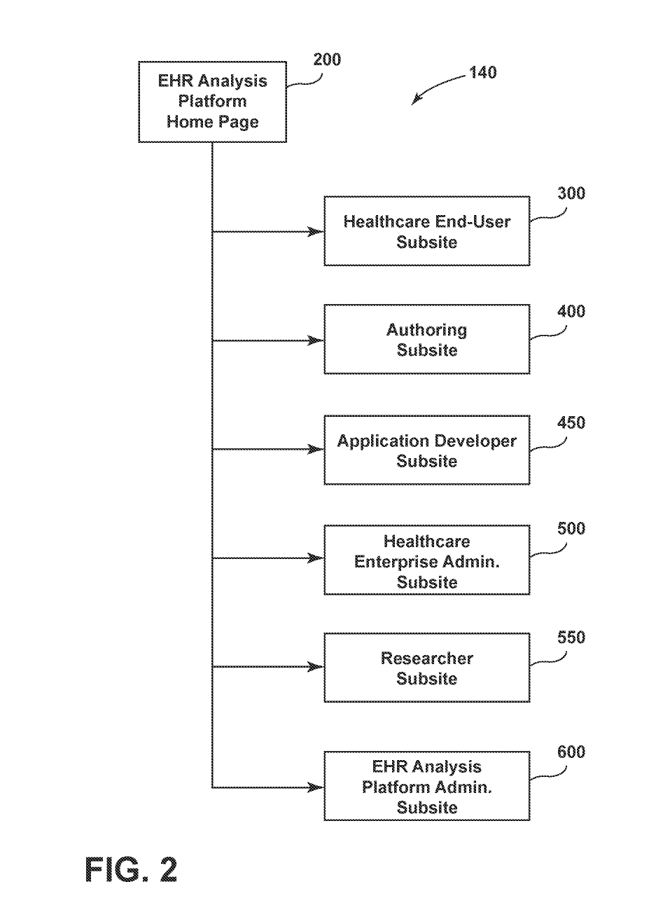

FIG. 2 is a diagram of one embodiment of the architecture for the EHR analysis platform website 140. The website 140 comprises a homepage 200, preferably having a URL, or web address, at a top level internet domain, such as, for example, www.EHRAnalysisCo.com. In other embodiments, the home page 200 may have a URL at other than a top level domain. In still other embodiments, the home page 200 may be customized for a specific healthcare enterprise 110 and may be associated with a web address related to the healthcare enterprise 110 for each of use of its end-users 114, such as, for example, www.ABCHospital.org/EHRAnalysis/. In the embodiment of website 140 illustrated in FIG. 2 and as described herein, homepage 200 resides on the EHR analysis platform server 138. A custom web address may simple redirect end users 114 to the EHR analysis website 140 on the platform server 138. In other embodiments, homepage 200 may be hosted on a webserver of the healthcare enterprise 110.

In the embodiment illustrated in FIG. 2, homepage 200 contains links to several subsites related to the various services and benefits offered by the system 100. In particular, subsite 300 is directed to healthcare enterprise end users 114, subsite 400 provides a platform in which application developers 120 and/or healthcare enterprise end users 114 can design, create and compile insight tools 122, subsite 450 is directed to application developers 120, subsite 500 is directed to healthcare enterprise administrators 116, sub site 550 is directed to independent researchers 160 and subsite 600 is directed to the administration of the EHR analysis platform 136. Other subsites are possible and one skilled in the art should recognize that not all subsites are necessary or required for operation of all possible embodiments of the EHR analysis web site 140. Specific embodiments of each of the identified subsites will now be described in detail.

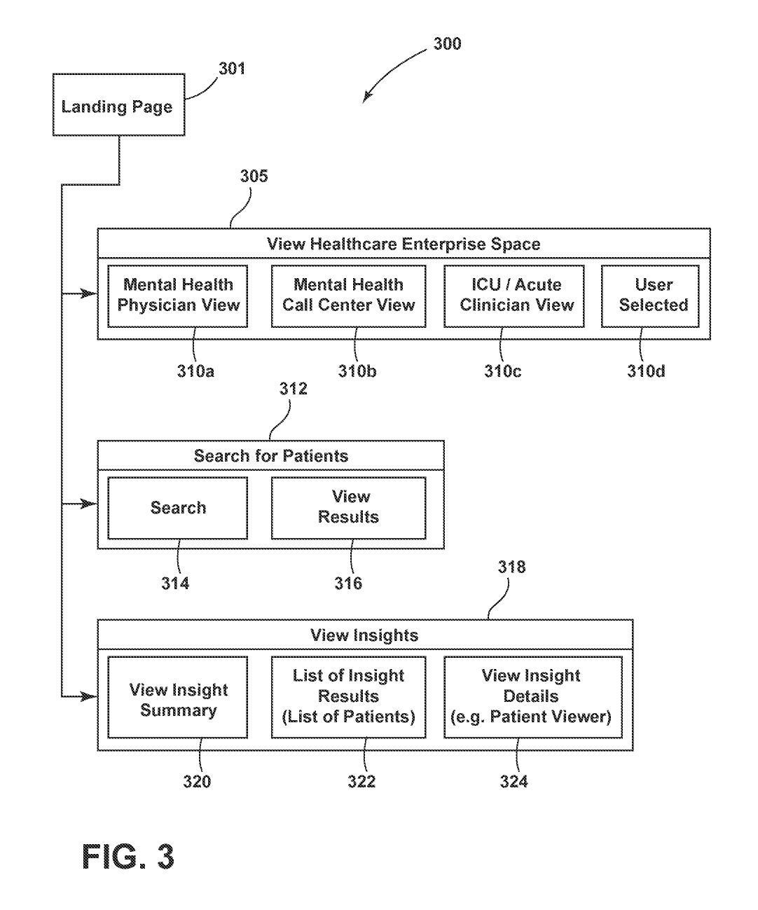

The healthcare user subsite 300, illustrated in FIG. 3, is the main area of the website 140 to be accessed and used by healthcare provider end users 114. The healthcare user subsite 300 provides for the presentation of patient data, algorithms, insights, valuesets and measures related to the consolidated EHR data 146 and the visualization of results of the insight tools 122 for which a healthcare provider end user 114 is allowed to access.

In the embodiment illustrated in FIG. 3, after accessing the subsite 300 from the home page 200, the website will present a pre-configured landing page 301 that is an introduction to the subsite 300. The landing page 301 may have a standard set of spaces and elements that provide end users 114 with access to their healthcare provider enterprise 110 specific environment.

In an embodiment, all end users 114 are required to navigate through the landing page 301 to access the content featured in the subsite 300. In one embodiment, the landing page can provide access to the environment for an end-user 114's affiliated healthcare provider enterprise 110. The landing page 301 can include an access control mechanism in which end users 114 are required to provide their credentials, typically a username and password, in order to access the rest of the subsite 300. The access control mechanism is not limited to using a password-based authentication method, and in other embodiments can employ commonly known multi-factor authentication methods.

The access rights granted to a specific end user 114 can be set and controlled by the healthcare provider enterprise administrator 116. In other embodiments, the inputting of credentials can occur before the landing page 301, such as at the home page 200, and entry into the subsite 300 can by-pass the landing page 301. Once the proper access rights for the end user 114 has been confirmed on the landing page 301, the end user 114 is presented with various topics and features that the end user 114 has rights to access.

One such topic, in an embodiment, is the View Healthcare Enterprise Space 305, the name of which can be customized for a specific healthcare enterprise 110, and may be named, for example, “View Hospital Space.” The View Healthcare Enterprise Space 305 is an environment with one or more possible views 310 relevant to the end user 114. Views 310, in an embodiment, may be various pre-configured views of the consolidated EHR data 146 presented in a fashion and format relevant to the end user 114. Views 310 may also be specific and relevant views of information or data of the healthcare provider enterprise, other than patient data.

In one embodiment, the views 310 available to the end user 114 are controlled by the healthcare enterprise administrator 116. In another embodiment, the specific views 310 that are presented to the end user 114 can be based on a specific role assigned to the end user 114, such as by specialty for physicians. In another embodiment, only some of the views 310 presented to an end user 114 may be controlled by the enterprise administrator 116 and the end user 114 may have the ability to select some of the views 310 presented in space 305. In still further embodiments, the views 310 presented in space 305 may or may not be based on the role of the end user 114 or may be based on some other characteristic, such as, for example, the facility the end user 114 is assigned to.

FIG. 3 shows an embodiment where, for example, where an end user 114 having the user role of a mental health physician would be presented with view 310a, which is within a mental health physician profile for the healthcare provider enterprise 110. View 310a, labeled a “Mental Health physician view” in the embodiment illustrated in FIG. 3, represents a pre-configured view of the different elements and components that are appropriate for the mental health physician profile. The information presented in view 310a is intended to help the mental health physician quickly identify and assess meaningful segments of her patient populations based on certain criteria, e.g. high-risk patients, patients that are missing certain assessments, follow-ups that need to be performed.

In another example, as illustrated in FIG. 3, an end user 114 having the role of mental health call center staff may be presented with view 310b, containing information and tools relevant for such users. View 310b may be capable of allowing the end user 114 to access a patient search function, view the returned search results, and to navigate to a patient details view with various sections of information about the patient organized in a timeline view, for example.

In still another environment, also as illustrated in FIG. 3, an end user 114 having the role of an ICU/acute care physician may be presented with view 310d, labeled as the “ICU/acute care clinician view” in FIG. 3. View 310d may be configured to provide relevant information about the patients in an active ICU or acute care unit of an healthcare provider enterprise 110. For example, view 310d may provide the acute care physician with lists of patients that meet specific criteria, e.g. those for which a specific action should be taken by the physician. needed red alert because the clinician should take specific actions. View 310d may also be configured to provide an overall performance summary for the specific ICU or acute care unit using various patient criteria such as, for example, length of stay in the ICU/acute care unit, number of complications, infection rates, etc.

Another feature of subsite 300 that an end user 114 may be able to access after confirming credentials on the landing page 301, if the end user 114 has the appropriate access rights, is a patient search environment 312. In an embodiment, as illustrated in FIG. 3, the patient search environment 312 comprises a patient search view 314, which may be configured to allow the end user 114 to search for patients using one or more patient facts as search criteria, alone or in combination. The patient search environment 312 further comprises a results view 316, which will display a list of patients having the specified one or more patient facts. From the search results, the end user 114 may be able to navigate to a detailed view of a specific patient.

A further feature of subsite 300, in one embodiment, is an insight viewer environment 318. This environment 318 allows the end user to view and interact with the insight tools 122 that have been developed or acquired by the healthcare provider enterprise 110 and made available to the end user 114 through the end user 114's access rights. The insight environment 318 may include an insight summary widget 320, that may present a summary view of the results of one or more different insight tools that is relevant to the end user 114's patients or practice area. For example, in an embodiment, the insight summary widget 320 may display a count of certain facts related to the end user's patients, such as the number of patients recently diagnosed with Type 2 diabetes. The insight summary widget 320 may also display trend graphs based on historical and comparative fact data about the end user's patients.

In another embodiment, instead of, or in addition to, the insight summary widget 320, the insight viewer environment 318 may include a list of the insight tools 122 available to the end user 114, or icons representing the available insight tools 122, allowing the end user to select a specific insight to review.

The insight viewer environment 318 further may comprise a view 322 listing the results of one or more insight tools 122, which may include a representation of the insight outcome, bottom line, or the recommended clinical action that the end user should take with respect to one or more patients. The insight viewer 318 further may further comprise an insight details view 324, which can provide further details about the results of the insight tool for a particular patient and may include the ability for the end user to access the reasoning and rationale underlying the results of the insight tool. In another embodiment, the insight details view 324 may further include the ability for the end user to initiate specific action recommended by the insight tool results, such as order specific tests for the patient.

In the embodiment described above, the healthcare user subsite 300 has been described as a stand-alone webpage directly accessible from the EHR analysis platform home page 200. In should be understood by those skilled in the art that the information, data, use of insights tools 122 and results thereof, may be made accessible to end users 114 using various devices, methods, procedures and formats, such as by webpages, web portals, integrated with other applications via APIs (application programming interfaces) or directly from the EHR analysis platform 136 itself. As an example, in an embodiment, some or all of the contents of the healthcare user subsite 300 described above may be integrated with or into a healthcare provider EHR system 112, which can be web-based or stand alone software.

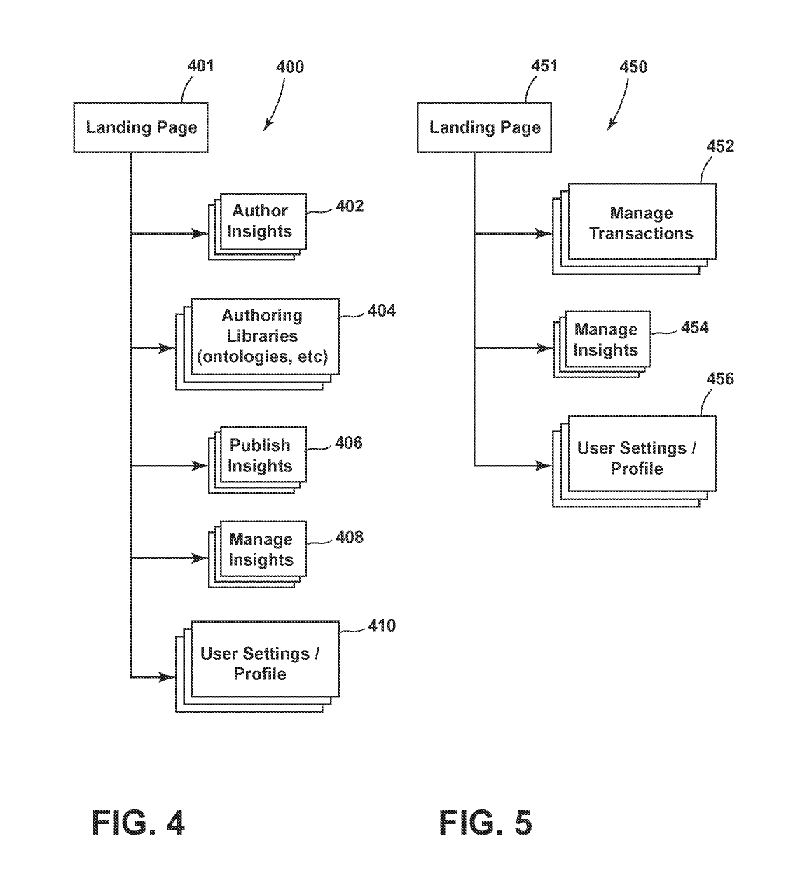

In an embodiment, entry to the authoring subsite 400, as illustrated in FIG. 4, is through landing page 401. Access to the authoring subsite 400 is based upon the specific access rights of user, as described above. If a healthcare enterprise 110 obtains access to the authoring platform 148 through the EHR analysis platform 136, then access to authoring subsite 400 can be granted to end users 114 by the healthcare enterprise administrator 116. Access to authoring subsite 400 by application developers 120 and researchers 160 may be granted directly through the EHR analysis platform 136. In an embodiment, both developers 120 and researchers 160 may control the access to authoring subsite 400 for specific users within their respective domains.

The landing page 401 of authoring subsite 400 may be pre-configured with a subset of spaces and environments relevant to authoring insight tools. One space may be an author insights space 402, which is space in which insights are authored. Examples of types of insight tools 122 that users may be able to author in the author insights space 402 are:
Algorithms—computations which can be executed upon data that can be stored in the EHR analysis platform 138.
Valuesets—clusters of computable objects that have formal representations and are defined as a set.
Measure—the output of a numerator over a denominator, usually expressed as a ratio or a percentage.
Population—data sets comprising complete or partial data from one or more patients.
Assessment—a clinical algorithm.

Another space in authoring subsite 400 is the authoring libraries space 404. In an embodiment, this space can provide access to the specific ontologies available on the EHR analysis platform 136, preferably including all the ontologies used to store the consolidated EHR data 146 in the platform database 142. The libraries space 404 may also include services and APIs included in the EHR analysis platform 136 to simplify the conversion of consolidated EHR data 146 from the ontology it is stored with to an ontology desired for reporting results.

In some embodiments, a specific ontology used to store consolidated EHR data 142 may be proprietary to the healthcare provider enterprise 110 that owns the consolidated EHR data 146, or it may be owned by a third-party entity and licensed to the healthcare provider enterprise 110. In that case, access to that ontology through the authoring subsite 400 may be restricted to authorized users only. End users 114 of the healthcare provider enterprise 110 may or may not have automatic access to the restricted ontology. If the healthcare provider enterprise 110 has sufficient right to license the ontology for use by others, application developers 120 and researchers 160 may contract with the healthcare provider enterprise 110 for access through the EHR analysis platform 136, which then would grant access to the ontology to the authorized developers 120 and/or researchers 160.

Once an insight tool is completed, an insight tool author can make use of insight tool publishing space 406, which provides a publishing process for the creation of runnables (application packages) for others to be able to make use of the authored insight tools. Insight tool authors can view how the completed authored product will be used by the various types of end-users.

Management of in-process and published insights is provided in the manage insight tool space 408. Here, insight tool authors may be able to save draft versions of insight tools that are authored, edit, copy and create new versions of insight tools that have been created and track insight usage.

A standard user settings space 410 is also included in the subsite 400 and is globally the same throughout the EHR analysis website 140. The user setting space 410 allows the user to collect, store and modify the user's profile information, to the extent the user has sufficient rights to do so.

EHR analysis website 140 may also comprise an application developer subsite 450 that allows application developers to initiate and manage their relationship with the EHR analysis platform 136. As illustrated in FIG. 5, the developer subsite 450 comprises a landing page 451 similar to the landing pages described above, having a means for authenticating the user and, once authenticated, providing the user with access to environment spaces relevant to application developers 120.

In an embodiment, a transaction management space 452 may be provided that allows an application developer 451 oversee and manage the financial aspects of all transactions that it is involved with on the EHR analysis platform 136. For instance, the application developer may set a price for access to and use of any insight tools 122 authored by the application developer 120 and published via the authoring subsite 400. In an embodiment, the application developer 120 may have a choice from multiple options for setting the price for access to an insight tool 122. For example, unlimited access for all end users of a healthcare provider enterprise may be provided for a one-time fee. Or the fee may be a recurring fee, such as yearly or monthly. Or the fee for access may be based on the number of end users 114 that make use of the insight tool 122 or the number of patients evaluated using the insight tool 122. It should be understood that the pricing model used to control access to an insight tool is not limited by these examples.

The transaction management space 452 may also provide the ability for financial transactions to occur between the authors of insight tools 122 (i.e., application developers 120) and entities seeking access to the insight tools. The EHR analysis platform server 138 may be configured to securely complete such financial transactions through the EHR analysis website 140. In other embodiments, the transaction management space 452 may direct the application developer to a third-party website to conclude any financial transactions.

The application developer subsite 450 may further include an insight tool management space 454, providing application developers 120 with the ability to control access to and monitor those insight tools 120 that have been leased through the transaction management space 452. A user settings space 456 may also be provided in the application developer subsite 450, having the same features and previously described.

Healthcare Enterprise Subsite

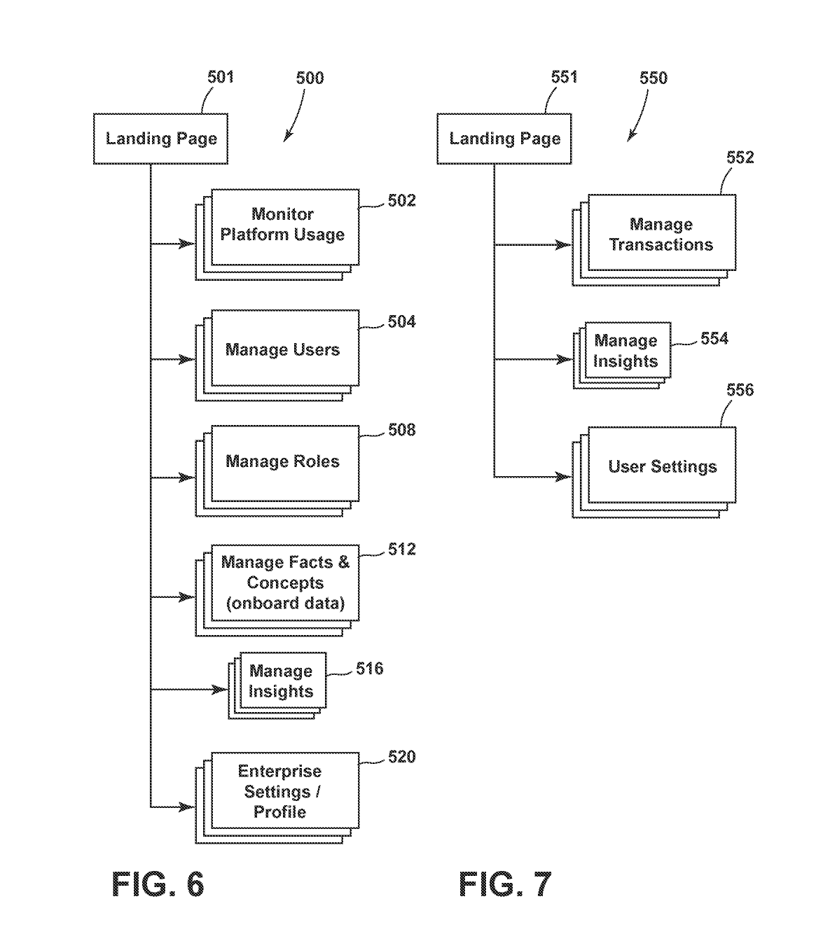

Healthcare provider enterprises 110 may provide specific individuals with the ability to serve as administrators of the enterprise's relationship with the EHR analysis platform 136. As mentioned previously, subsite 500 of EHR analysis website 140 is directed to such healthcare enterprise administrators 116. As illustrated in FIG. 6, entry to subsite 500 is through landing page 501, which contains a user authentication process and a pre-configured subset of spaces and environments relevant to and applicable for healthcare enterprise administrators 116. Landing page 501 may also include summaries of information that may be important to healthcare enterprise administrators 116 or beneficial to have before proceeding to one of the spaces or environments. For example, the landing page 501 may include a list of action items that require immediate attention, such as user access requests and insight tool access request, and real-time information such as current usage activity for the platform, users, departments or on specific insight tools.

As further illustrated in FIG. 6, landing page 501 may direct a healthcare enterprise administrator 116 to platform usage monitoring space 504, which may provide a way for enterprise administrators 116 to monitor how the services on EHR analysis platform 136 are being used by the healthcare provider enterprise 110. Space 504 may provide the ability to identify if all leased insight tools are running as needed, to view the activity on the EHR analysis platform 136 for a specific end user 114, identify all the different products/services of the EHR analysis platform 136 that are running for the healthcare provider enterprise 110 and view detailed usage activity for specific insight tools 122. Additional features and tools may be included in space 504 and different healthcare provider enterprises 110 may have the more or less features configured for space 504. In an embodiment, space 504 may also be configured to allow enterprise administrators 116 to obtain information related to the costs and benefits of the EHR analysis platform 136, including the ability to monitor the specific costs related to usage of individual insight tools 122.

Subsite 500 also provides healthcare enterprise administrators 116 with the ability to manage users in space 504, also accessed from the landing page 501. The features in space 504 may include the ability to add, suspend, modify and delete end users, generate invitations to onboard new end users that are granted access to the platform and manage profiles of end users. The ability to provide specific access rights not related to the role of an end user 112 may also be provided in space 504.

In an embodiment, access rights in the EHR analysis platform 136 are primarily based on a user's defined role. In other embodiments, access rights may be based on other factors, however. Subsite 500 provides the ability of healthcare provider enterprise administrators 116 to manage user roles through space 508. This includes the ability to associate roles with specific permissions and actions within the EHR analysis platform 136. This can include, for example, associating user roles with access rights to specific portions of the EHR analysis web site 140 and defining specific pre-configured user interface views based on user roles. Additionally, space 508 may provide a healthcare provider enterprise administrator 116 with the ability to map roles on the EHR analysis platform 136 with roles from other third-party authentication methods.

Space 512 in subsite 500 is configured to allow healthcare enterprise administrators 116 to upload and manage the EHR system data that is transmitted to the EHR analysis platform database 146. Specifically, space 512 allows the enterprise administrator to specify the format of the date in the EHR system 112 and identify how that format is mapped to the platform knowledge model of the EHR analysis platform 136. The specific capabilities of space 512 may include, as examples only, the ability to specify the source of the existing EHR system data, to specify the relationship for how the data is connected to the EHR analysis platform 136 and to associate known areas within the healthcare enterprises 110's data structure/model to specific areas within the EHR analysis platform 136's knowledge model. The enterprise administrator may further have the ability to identify the vocabularies and ontologies used to store the date in the healthcare provider EHR system 112.

In an embodiment, space 512 may further provide the ability to grant and manage access to the healthcare provider enterprise 110's consolidated EHR data 146 contained in the EHR analysis platform database 142. Access to the consolidated data may be granted to researchers 160, for example, with space 512 allowing the enterprise administrator to define the conditions and restrictions attached to such access. Such conditions and restrictions may include financial considerations paid by the researchers 160 for use of the consolidated EHR data 146 and space 512 may be configured to facilitate such a transaction entirely within the EHR analysis platform system.

An important and critical function of subsite 500, provided through space 516, is to provide the ability for the enterprise administrator to manage the insight tools available to the end users 114 of the healthcare provider enterprise 110. This includes the ability to lease, license or otherwise secure rights to use insight tools available on the EHR analysis platform 136, including insight tools authored on the authoring platform 148 and published to the EHR analysis platform 136. Space 516 further provides the ability to specify the specific insight tools that are available for use by the enterprise end users 114 on the EHR analysis platform 136, specify the degree to which end users 114 are able to configure specific aspects of the insight tools and manage the access rights to those insight tools based on user roles or other user characteristics.

Space 516 also provides the ability to configure the insight tools based on the unique needs of the healthcare provider enterprise 110. Further, space 516 allows an enterprise administrator 116 to define the process by which end users 114 may request, and receive approval for, access to insight tools outside of those already accessible to the healthcare provider enterprise 110. In an embodiment, space 516 may provide the for the ability to transact with application developers 120 for the purchase, lease or license of authored insight tools 122, and may interact with transaction management space 452 in subsite 450 to complete such a transaction.

Similar to the common user profile spaces 410 and 456, enterprise settings space 520 in subsite 500 provides the enterprise administrator 116 with the means to set-up and maintain the profile of the healthcare provider enterprise 110. Examples of characteristics of the enterprise 112 that may exist in its profile, and managed by space 520, is the enterprise's identifying information, its credentialing process, its access plan for the EHR analysis platform 136, its billing information and its organizational and insight tool governance structure.

It should be understood that the administrative functions available to healthcare enterprise administrators 116 may be more or less than the extent of the capabilities described herein. For example, in an embodiment, the administrative functions relating to providing user access to specific insight tools 122 may be controlled by the an administrator of the EHR analysis platform 136. It should be understood by one skilled in the art that providing more or less capabilities to healthcare enterprise administrators 116 is within the scope of the embodiments disclosed herein and/or contemplated by the inventors.

The research subsite 550 is geared toward independent researchers 160. As illustrated in FIG. 7, subsite 550 also includes a landing page 551, which includes means for authentication of a user prior to providing access to pre-configured spaces and environments. The spaces and environments relevant for researchers 160 are, in one embodiment, very similar to the spaces and environments relevant to other users. Transaction management is provided by space 552, which is configured similarly to transaction management space 452 in subsite 450 related to application developers 120. One difference, however, is that researchers 160 may primarily be consumers of insight tools 122 published on the EHR analysis platform 136 as well as of the consolidated EHR data 146 that healthcare provider enterprises 110 offer to license on the EHR analysis platform 136. Space 552 may facility the financial transactions between researchers 160 and application developers 120 for use of published insight tools 122, and between researchers 160 and healthcare provider enterprises 110 for access rights to the consolidated EHR data 146.

In an embodiment, researchers 160 may also be provided access to the authoring platform 148 and they may thus author and publish insight tools 122 for use by other entities on the EHR analysis platform 136. Space 552 may be configured to facilitate the transactions that may result from the publication of those insight tools 122, much in the same way that transaction management space 452 is configured. Of course, researchers 160 may be allowed use authoring platform 148 to author insight tools 122 for use only by the researchers 160.

Insight tools 122 that researchers 160 license or lease from others, as well as those authored by the researchers themselves, can be managed through insight tool management space 554. This space is configured similarly to insight tool management space 454 under sub site 450 and provides similar features and functions to researchers 160.

Subsite 550 also contains a user settings space 556 that is similar in function and purpose as the user settings sites 410 and 456.

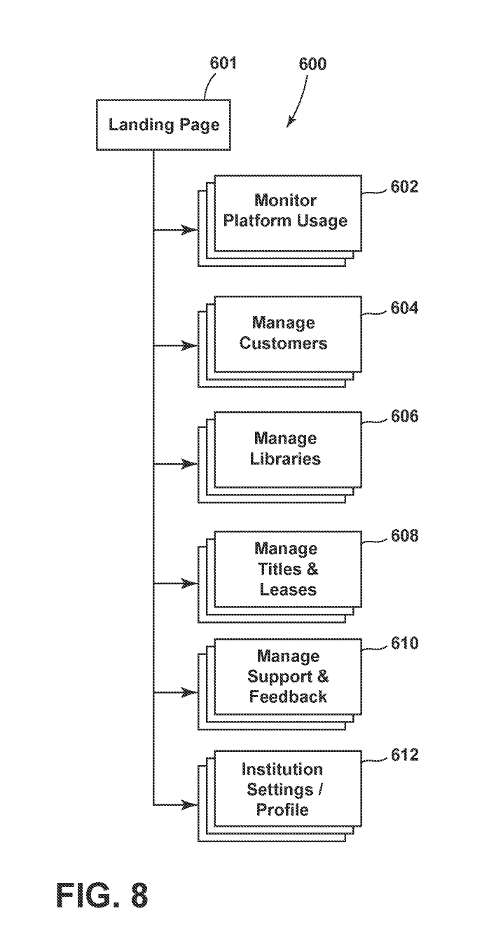

The final subsite illustrated in FIG. 2, subsite 600, is directed to the administration of the EHR analysis platform 136 and is illustrated in FIG. 8. In an embodiment, subsite 600 is not accessible to the public or any other user on the EHR analysis platform 136 except for administrative users of the EHR analysis platform 136.

Subsite 600 includes a landing page 601 having authentication means and providing multiple pre-configured spaces and environments relevant to the administration of the EHR analysis platform 136. Specific spaces illustrated in FIG. 8 include space 602 providing the ability to monitor usage on the EHR analysis platform 136 across all users and entities. Customer management space 604 provides functions for managing the customers of the EHR analysis platform 136, including healthcare provider enterprises 110, application developers 120 and researchers 160. Space 604 may be configured to provide the ability to manage all aspects of the relationship between the EHR analysis platform 136 and its customers.

Library management space 606 provides features and functions to manage the multiple vocabularies, ontologies and other libraries used for the storage of consolidated EHR data 146 and for the authoring of insight tools 122.

Asset control space 608 includes functions and features for managing the ownership of assets on the EHR analysis platform 136, where assets can be published insight tools or consolidated EHR data made available for use. Space 608 is further configured to manage the rights granted by asset owners to others, through license, lease or outright sale, including enforcement of any access restrictions or conditions placed on the grant of rights. In an embodiment, space 608 may also be configured to facilitate financial transactions between the asset owners and entities obtaining rights in the assets.

Platform administration subsite 600 further includes space 610 for managing the support and feedback functions of the EHR analysis platform 136. The specific functions utilized can comprise of one or more of the many different common types of website support and feedback methods and system and this disclosure should not be understood to be limiting to any one type of support or feedback function.

Profile space 612 provides the ability for the EHR analysis platform 136 administrator to define and manage the setting and profile of the owner of the EHR analysis platform 136 as desired and in similar fashion as the user profile spaces 410, 456 and 520.

Although a number of embodiments have been described above with a certain degree of particularity, those skilled in the art could make numerous alterations to the disclosed embodiments without departing from the sprit or scope of this disclosure. For example, all joinder referenced (e.g., attached, coupled, connected, and the like) are to be construed broadly and may include intermediate members between a connection of elements and relative movement between elements. As such, joined references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by referenced herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system for the storage, management and analysis of electronic health records (“EHRs”), the system comprising:
an EHR analysis system operating on one or more servers and in communication with one or more EHR systems of one or more healthcare provider enterprises via one or more networks, the EHR analysis system receiving EHR data and information identifying the storage format of the EHR data, from at least one of the EHR systems;
a database of the EHR analysis system, the database configured to electronically store the EHR data received from the at least one EHR system along with the information identifying the storage format of the EHR data;
an authoring platform system for building one or more applications to analyze specified EHR data stored in the database of the EHR analysis system, the authoring platform system comprising:
authoring tools for defining one or more operations to be performed on the specified EHR data in an authored application; and
publishing tools for offering the authored application to the one or more healthcare provider enterprises for analysis of the consolidated EHR data stored on the database of the EHR analysis system; and
a processor in communication with the database of the EHR analysis system, the processor configured to receive a request to transmit EHR data stored in the database of the EHR analysis system, the request specifying a requested format for the EHR data, wherein the processor is configured to convert the EHR data before transmission if the requested format is different than the storage format for the EHR data;
wherein the processor is further configured to manage the access to the EHR data stored in the database of the EHR analysis system based on the specific healthcare provider enterprise from the EHR data was received from, the processor being further configured to manage the access to the authored application, and
wherein the processor is further configured to receive a request from a healthcare provider enterprise to execute an authored application using specific consolidated EHR data stored on the database of the EHR analysis system and transmitting the results of the execution of the authored application to the requesting healthcare provider enterprise for display on a client processing device.

2. The system of claim 1, wherein the client processing device is one of a mainframe computer, server, desktop computer, web terminal, laptop computer, netbook computer, hand-held computer, tablet and smartphone.
